(19) United States
(12) Patent Application Publication
(10) Pub. No.: US 2003/0235139 A1
(43) Pub. Date: Dec. 25, 2003

(54) Head driving apparatus for disk apparatus

(75) Inventor: Makoto Takeuchi, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/457,371

(22) Filed: Jun. 10, 2003

(30) Foreign Application Priority Data
Jun. 20, 2002 (JP) 2002-179307

(51) Int. Cl. G11B 17/30; G11B 21/02; G11B 17/00; G11B 21/16

(52) U.S. Cl. 369/223; 369/249

(57) ABSTRACT

A head driving apparatus is disclosed which allows smooth movement of a pickup head even if the parallelism between the guide rails for guiding the pickup head and a lead screw for moving the pickup head is deteriorated. A toothed member is mounted for pivotal motion on a Z-X coordinate plane perpendicular to an X-Y coordinate plane on which the pickup head is moved around a pivot formed from a boss and a bush against the frictional force by a tooth spring. The pivotal motion of the toothed member is allowed only within a range within which both of claw portions can rock in slits. When the toothed member is pivotally moved to a position at which the drag is smallest, the teeth of the toothed member are directed to an angle same as the flank angle of the screw threads of the lead screw and are automatically corrected so that the teeth and the screw threads of the lead screw enter into an appropriate meshing engagement state.

### BACKGROUND OF THE INVENTION

1. Field of the Invention

The present invention relates to a disk recording apparatus and particularly to a disk apparatus for recording or reproducing information onto or from a recording disk such as a compact disk (CD) and a digital versatile disk (DVD), and more particularly to a head driving apparatus for moving a pickup head with respect to a recording disk.

2. Description of the Related Art

In resent years, development of an optical disk apparatus as a disk recording apparatus has proceeded. Particularly, a writing function has been additionally provided to a recording apparatus for an optical medium such as a CD-ROM, and, also for a driving apparatus for moving an optical pickup unit (OPU) as a pickup head for recording an information signal onto an optical disk in a radial direction of an optical disk, a function for feeding the optical pickup unit smoothly and accurately is demanded. At the same time, in order to achieve high-quality writing of writing data, an apparatus for adjusting the posture of the optical pickup unit so that an optical axis of laser light emitted from the optical pickup unit and a recording face of an optical disk may extend perpendicularly to each other is demanded.

As such an optical disk driving apparatus as described above, an apparatus is available which moves the optical pickup unit using a lead screw. FIG. 1 is a schematic view showing an appearance of a general configuration of an optical disk driving apparatus as viewed from the top face side, and FIG. 2 is a bottom plan view of the optical disk driving apparatus. A spindle motor 4 for rotationally driving an optical disk D indicated by a chain line in FIG. 1 is provided on a chassis 2 formed by working a metal plate or the like. A pair of main and sub guide rails 3a and 3b are supported in parallel in a predetermined spaced relationship from each other in a Y-axis direction on the chassis 2 such that they extend in an X-axis direction (radial direction of the optical disk) on a plane of X-Y coordinates. An optical pickup unit 1 is mounted for reciprocating sliding movement on the guide rails 3a and 3b. Further, a lead screw 5 having screw threads formed on a circumferential face thereof is supported for rotation in parallel to the main guide rail 3a on one side of the chassis 2. The lead screw 5 is rotatable in both of forward and reverse directions by a driving mechanism 6 including a motor not shown and a speed reduction mechanism 6a. Further, a tooth unit 10 is provided on the optical pickup unit 1 and is held in meshing engagement with the lead screw 5.

Referring to FIGS. 8(a), 8(b) and 9 which are a top plan view, a side elevational view and a perspective view, respectively, of the tooth unit 10, the conventional tooth unit 10 is formed by integrally connecting a toothed member 102 held in meshing engagement with the screw threads of the lead screw 5 and a tooth base 101 fixedly supported on the optical pickup unit 1. The tooth base 101 is fixed to the optical pickup unit 1 by a screw 106. Further, two teeth 105 are formed on a front face of the toothed member 102 and held in meshing engagement with the screw threads of the lead screw 5. The toothed member 102 is connected to the tooth base 101 by a pair of flexible connection pieces 103. The toothed member 102 is resiliently pressed to the lead screw 5 by a tooth spring 104 interposed between the toothed member 102 and the tooth base 101. Consequently, a meshing engagement state between the teeth 105 of the toothed member 102 and the screw threads of the lead screw 5 is kept.

In the optical head driving apparatus in which such a tooth unit as described above is used, if the lead screw 5 is rotated by the driving mechanism 6, then force acting in an axial direction (X-axis direction) of the lead screw 5 is generated on the toothed member 102 held in meshing engagement with the screw threads of the lead screw 5. Since the toothed member 102 is integrated with the optical pickup unit 1 through the tooth base 101, the force in the axial direction is applied to the optical pickup unit 1 to move the optical pickup unit 1 along the guide rails 3a and 3b. In particular, the optical pickup unit 1 is moved back and forth in the X-axis direction along the X-Y coordinate plane. Thereupon, laser light emitted from the optical pickup unit 1 is irradiated upon the optical disk D to allow recording or reproduction of data to be performed.

In the optical head driving apparatus, in order that the optical axis of the laser light emitted from the optical pickup unit 1 and the recording face of the optical disk D extend perpendicularly to each other in the Z-axis direction as described above, a skew adjustment portion 7a is provided at one end of the main guide rail 3a and a pair of skew adjustment portions 7b and 7c are provided at both ends of the sub guide rail 3b. By the skew adjustment portions 7a, 7b and 7c, the inclination of the guide rails 3a and 3b with respect to the chassis 2, that is, the angle between them in the Z-axis direction, is adjusted to adjust the posture of the optical pickup unit 1 so that the laser light emitted from the optical pickup unit 1 can be irradiated perpendicularly in the Z-axis direction upon the recording face of the optical disk D.

However, in the optical head driving apparatus having such a configuration as described above, if the skew of the main and sub guide rails 3a and 3b is adjusted by the skew adjustment portions 7a, 7b and 7c so that the laser light of the optical pickup unit 1 may be directed perpendicularly to the recording face of the optical disk D, then there is the possibility that the parallelism between the main and sub guide rails 3a and 3b and the lead screw 5 in the Z-axis direction may be deteriorated. If the parallelism between the guide rails 3a and 3b and the lead screw 5 is deteriorated, then the teeth 105 of the toothed member 102 supported on the optical pickup unit 1 which moves along the guide rails 3a and 3b and the screw, threads of the lead screw 5 are brought out of meshing engagement with each other with a normal angle, resulting in generation of high drag or excessive frictional force between them. As a result, smooth movement of the optical pickup unit 1 along the guide rails 3a and 3b is obstructed. Therefore, the quality of writing by the optical disk recording apparatus, for example, onto a CD-ROM is degraded.

It is to be noted that Japanese Patent Laid-Open No. 2001-160272 discloses an apparatus wherein a rack (toothed member) provided on an optical pickup unit is resiliently pressed to a lead screw to achieve smooth movement of the optical pickup unit. However, the apparatus controls the inclination of the rack to secure a meshing engagement state between the rack and the lead screw and presupposes that a parallel state between the guide rails and the lead screw is secured. Therefore, it is difficult to solve such a trouble when the parallelism between the guide rails and the lead screw in the Z-axis direction is deteriorated as described above using the apparatus.

### SUMMARY OF THE INVENTION

It is an object of the present invention to provide a head driving apparatus which can correctly adjust the posture of an optical pickup unit and can smoothly move the optical pickup unit.

In order to attain the object of described above, according to an aspect of the present invention, there is provided a head driving apparatus for a disk apparatus comprising a pickup head movable in an X-axis direction on a plane of X-Y coordinates along a guide rail for performing recording or reproduction of information onto or from a recording disk, a lead screw rotationally driven to move the pickup head in the X-axis direction, and a toothed member held in meshing engagement with the lead screw for moving the pickup head in the X-axis direction upon rotation of the lead screw, the toothed member being supported for pivotal motion on the pickup head within a range of a small angle on a plane of Z-X coordinates perpendicular to the X-Y coordinate plane on which the pickup head is moved.

Preferably, the toothed member is supported for pivotal motion on the pickup head within a range of a small angle also in the X-Y coordinate plane on which the pickup head is moved.

The toothed member may be disposed for pivotal motion with respect to the pickup head by means of a pivot extending in a Y-axis direction.

The head driving apparatus may further comprise a tooth base provided on the pickup head, and the toothed member may be supported for pivotal motion on the tooth base by the pivot extending in the Y-axis direction.

The head driving apparatus may further comprise a tooth spring interposed between the toothed member and the tooth base for resiliently pressing the toothed member to the lead screw and braking the pivotal motion of the toothed member. The tooth spring may be a coil spring arranged around the pivot.

Preferably, the pivot is formed from a boss provided on a rear face of the toothed member and inserted in a bush provided on a front face of the tooth base. Further preferably, the bush and the boss form a spherical bearing structure.

The head driving apparatus may be configured such that a pair of claw portions are provided on a rear face of the toothed member and inserted in a pair of slits, which are provided on a front face of the tooth base with clearances formed therebetween such that a pivotal motion of the toothed member within a small angle with respect to the tooth base is allowed by the clearances, and removal of the toothed member from the tooth base is prevented by the engagement between the claw portions and the tooth base.

The pickup head may be an optical pickup unit.

In the head driving apparatus for a disk apparatus, the toothed member can pivotally move within a range of a small angle on the Z-X coordinate plane rectangular to the X-Y coordinate plane on which the pickup head is moved. Therefore, even if the parallelism in the Z-axis direction between the guide rail and the lead screw is deteriorated, the toothed member is directed to a preferable angular position with respect to the lead screw so that the toothed member and the lead screw are brought into appropriate meshing engagement with each other. As a result, smooth movement of the pickup head is secured.

Further, the toothed member can pivotally move within a range of a small angle also on the X-Y coordinate plane on which the pickup head moves. Therefore, even if the parallelism in the Y-axis direction is deteriorated, the toothed member is pivotally moved in a follow-up manner so that the toothed member and the lead screw are brought into appropriate meshing engagement with each other. As a result, smooth movement of the pickup head is secured.

The above and other objects, features and advantages of the present invention will become apparent from the following description and the appended claims, taken in conjunction with the accompanying drawings in which like parts or elements are denoted by like reference symbols.

### BRIEF DESCRIPTION OF THE DRAWINGS

FIG. 1 is a schematic view showing an appearance of an optical disk apparatus to which a head driving apparatus of the present invention can be applied as viewed from the top side;

FIG. 2 is a bottom plan view of the optical disk apparatus;

FIG. 3(a) is a top plan view showing a tooth unit in the head driving apparatus;

FIG. 3(b) is a side elevational view of the tooth unit;

FIG. 3(c) is a sectional view taken along line A-A of FIG. 3(a);

FIG. 3(d) is a sectional view taken along line B-B of FIG. 3(a);

FIG. 4 is an exploded perspective view of the tooth unit;

FIGS. 5(a) and 5(b) are schematic views of a toothed member of the tooth unit as viewed from the front side illustrating action of the head driving apparatus;

FIG. 6 is an exploded perspective view showing a modified head driving apparatus;

FIGS. 7(a) and 7(b) are schematic views of a toothed member as viewed from the top side illustrating action of the modified head driving apparatus;

FIG. 8(a) is a top plan view showing a tooth unit in a conventional head driving apparatus;

FIG. 8(b) is a side elevational view of the tooth unit in the conventional head driving apparatus; and

FIG. 9 is a perspective view showing the tooth unit shown in FIGS. 8(a) and 8(b).

### DESCRIPTION OF THE PREFERRED EMBODIMENT

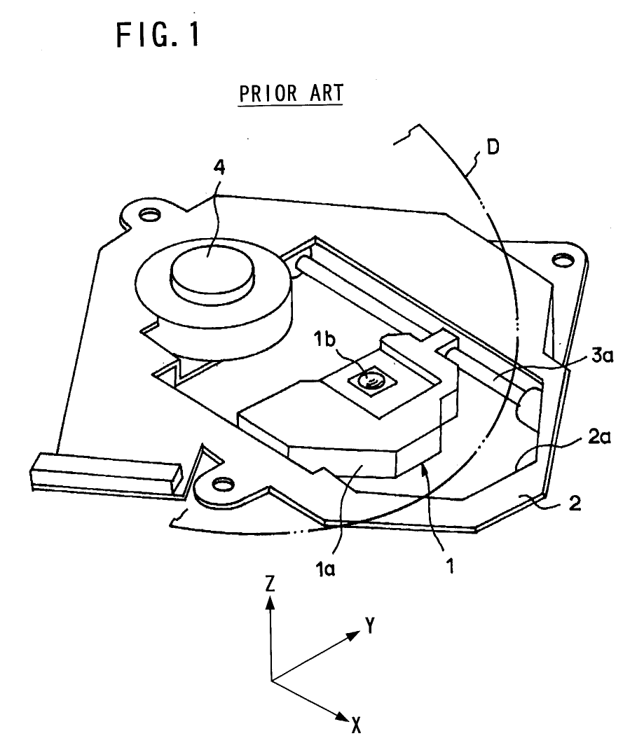

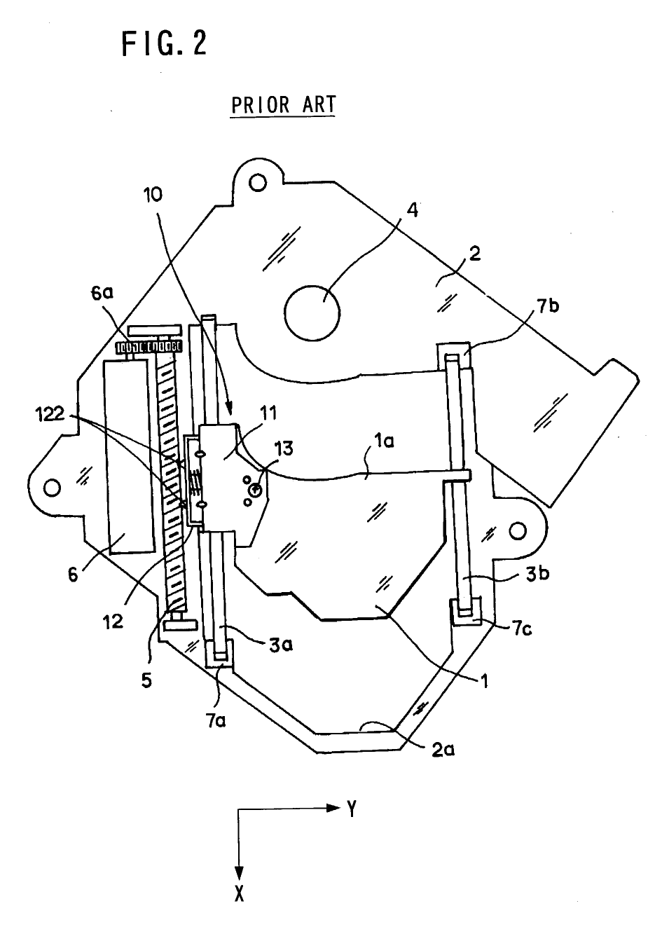

A head driving apparatus according to the present invention is applied to the optical disk apparatus described hereinabove with reference to FIGS. 1 and 2. Thus, the optical disk apparatus is described in more detail.

A spindle motor 4 is supported on a chassis 2 formed in a rectangular shape on a plane of X-Y coordinates and rotates an optical disk D indicated by a broken line in FIG. 1 at a high speed. A head moving window 2a is provided in the chassis 2. A pair of main and sub guide rails 3a and 3b are supported on the chassis 2 in parallel to each other and in a predetermined spaced relationship from each other in the Y-axis direction such that they extend in the X-axis direction (radial direction of the optical disk) and are exposed to the head moving window 2a. An optical pickup unit 1 is mounted for sliding movement on the main and sub guide rails 3a and 3b. For example, the optical disk apparatus is formed such that the guide rails 3a and 3b penetrate both side portions of a casing 1a of the optical pickup unit 1 so as to allow reciprocating movement of the optical pickup unit 1 in the X-axis direction along the guide rails 3a and 3b, that is, along the X-Y coordinate plane.

An objective lens 1b is provided on the optical pickup unit 1 and laser light is emitted from an optical device mounted in the optical pickup unit 1 to the optical disk D through the objective lens 1b to perform recording or reproduction of information. However, detailed description thereof is omitted herein because it does not directly relate to the present invention. Further, a skew adjustment portion 7a is provided at one end of the main guide rail 3a, and a pair of skew adjustment portions 7b and 7c are provided at both ends of the sub guide rail 3b. By the skew adjustment portions 7a, 7b and 7c, the supporting heights of the one end of the main guide rail 3a and both ends of the sub guide rail 3b are adjusted so that the inclination of the guide rails 3a and 3b in a Z-axis direction with respect to the chassis 2 can be adjusted. Since an adjustment mechanism by such skew adjustment portions is generally known, detailed description thereof is omitted herein.

A lead screw 5 having screw threads formed on a circumferential face thereof is supported for rotation at both ends thereof on one side of the chassis 2 such that it extends in the X-axis direction. The lead screw 5 is arbitrarily rotatable in both of forward and reverse directions by a screw driving mechanism 6 including a motor not shown and a speed reduction mechanism 6a. Further, a tooth unit 10 is provided on the casing 1a of the optical pickup unit 1 and is held in meshing engagement with the lead screw 5 as hereinafter described.

The tooth unit 10 includes a tooth base 11 and a toothed member 12 separate from the tooth base 11. The tooth base 11 is integrally fixed to the casing 1a of the optical pickup unit 1 by a screw 13. Further, a plurality of teeth 14 are provided on the toothed member 12 in such a manner as herein after described. The teeth 14 are held in meshing engagement with the screw threads of the lead screw 5.

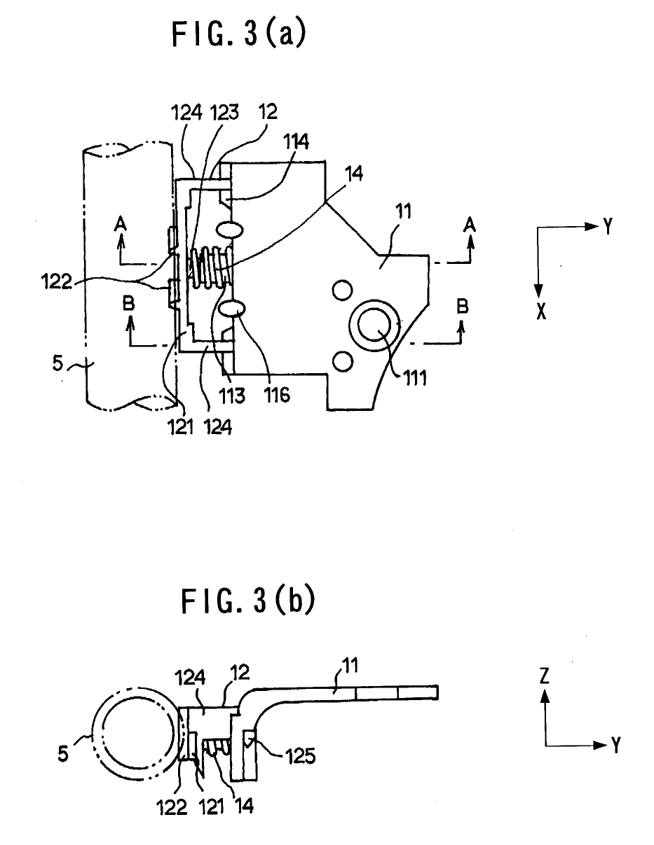

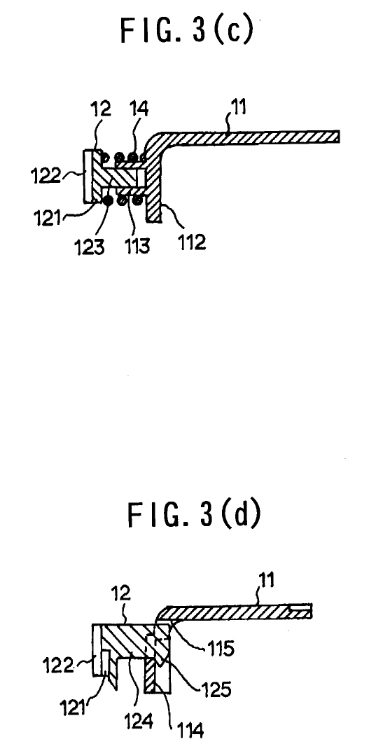

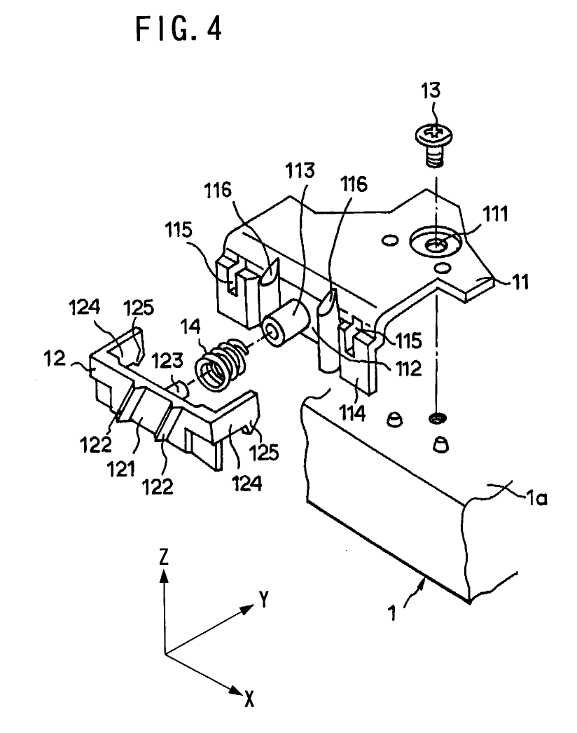

Referring now to FIGS. 3(a) to 3(d) and 4, the tooth base 11 is fixedly fastened to part of the casing 1a of the optical pickup unit 1by the screw 13 inserted in a screw hole 111 formed at part of the tooth base 11. A tooth supporting portion 112 curved in an L shape in a downward direction is formed on one side of the tooth base 11. A bush 113 having a cylindrical shape is integrally formed in a projecting manner at a substantially central position in the leftward and rightward longitudinal direction of a front face of the tooth supporting portion 112. Further, left and right ends 114 of the front face of the tooth supporting portion 112 are bulged forwardly, and slits 115 are individually formed at the bulged portions. Further, ribs 116 are formed in a projecting manner on the front face of the tooth supporting portion 112 in a slightly spaced relationship on both left and right sides of the bush 113.

The toothed member 12 includes a vertical front plate portion 121 and vertical left and right side plate portions 124 formed by bending a plate piece into a U shape in plan. On the front face of the front plate portion 121, two inclined teeth 122 for engaging with the screw threads of the lead screw 5 are formed in parallel to each other with an angle equal to the flank angle of the screw threads of the lead screw 5. A circular boss 123 projects at a central position of the rear face of the front plate portion 121 such that it can be inserted into the bush 113 of the tooth base 11. Further, claw portions 125 are formed in a projecting manner in a downward direction at tip ends of the left and right side plate portions 124 such that they can be inserted from above into the left and right slits 115 of the tooth base 11. Since the thickness of the left and right claw portions 125 is smaller than the width of the slits 115, if the left and right claw portions 125 are inserted into the slits 115, then a slight space is formed between the claw portions 125 and the slits 115. However, since the bottom ends of the left and right claw portions 125 are engaged with the rear face of the left and right ends 114 projecting from the tooth supporting portion 112, inadvertent removal of the toothed member 12 from the tooth base 11 can be prevented.

When the left and right claw portions 125 and the left and right slits 115 are set in such a relationship as described above, the boss 123 of the toothed member 12 is inserted into the bush 113 of the tooth base 11. In the state just described, the boss 123 is rotatable in the bush 113, and a slight space is formed between the left and right claw portions 125 and the slits 115 in such a manner as described above. Consequently, the toothed member 12 can pivotally move, using the boss 123 and bush 113 as a pivot, within a predetermined small angler range on a plane of Z-X coordinates perpendicular to the tooth base 11.

Further, a tooth spring 14 in the form of a compression coil spring is provided around the pivot formed from the boss 123 and the bush 113 and between the rear face of the front plate portion 121 of the toothed member 12 and the front face of the tooth supporting portion 112 of the tooth base 11. The tooth spring 14 biases the toothed member 12 toward the lead screw 5.

With the optical disk apparatus having the configuration described above, if the lead screw 5 is rotated by the driving mechanism 6 similarly as in the conventional apparatus, then since the teeth 112 are held in meshing engagement with the screw threads of the lead screw 5, the toothed member 12 is moved in an axial direction of the lead screw 5, that is, in the X-axis direction. By the fitting between the boss 123 and the bush 113 and the fitting between the left and right claw portions 125 and the left and right slits 115, the toothed member 12 is integrated with the tooth base 11 in the X-axis direction. Therefore, the tooth base 11 is moved together with the toothed member 12, and the optical pickup unit 1 which fixedly supports the tooth base 11 thereon is moved in the X-axis direction along the guide rails 3a and 3b. The toothed member 12 is resiliently pressed to the lead screw 5 by the tooth spring 14, and, at the same time, a posture of the toothed member 12 is maintained by frictional force generated by pressure contact between an end of the tooth spring 14 and the rear face of the toothed member 12. As a result, a preferable meshing engagement state between the teeth 122 and the screw threads is secured. Consequently, the optical pickup unit 1 is moved in a radial direction of the optical disk D rotated at a high speed by the spindle motor 4 so that recording or reproduction of information onto or from the optical disk D is performed by the optical device internally mounted in the optical pickup unit 1.

Incidentally, in the optical pickup unit 1, it is preferable that the laser light emitted from the optical device internally mounted in the optical pickup unit 1 is projected perpendicularly to a recording face of the optical disk D as described above. Therefore, the inclination of the guide rails 3a and 3b in the Z-axis direction with respect to the plane of the chassis 2 is adjusted by the skew adjustment portion 7a provided at one end of the main guide rail 3a and the skew adjustment portions 7b and 7c provided at the both ends of the sub guide rail 3b. Therefore, if the parallelism in the Z-axis direction between the main and sub guide rails 3a and 3b and the lead screw 5 is deteriorated, then since the toothed member 12 is supported by the optical pickup unit 1 which moves along the guide rails 3a and 3b, the toothed member 12 and the lead screw 5 are brought out of meshing engagement with each other with a correct angle. As a result, smooth movement of the optical pickup unit 1 is obstructed.

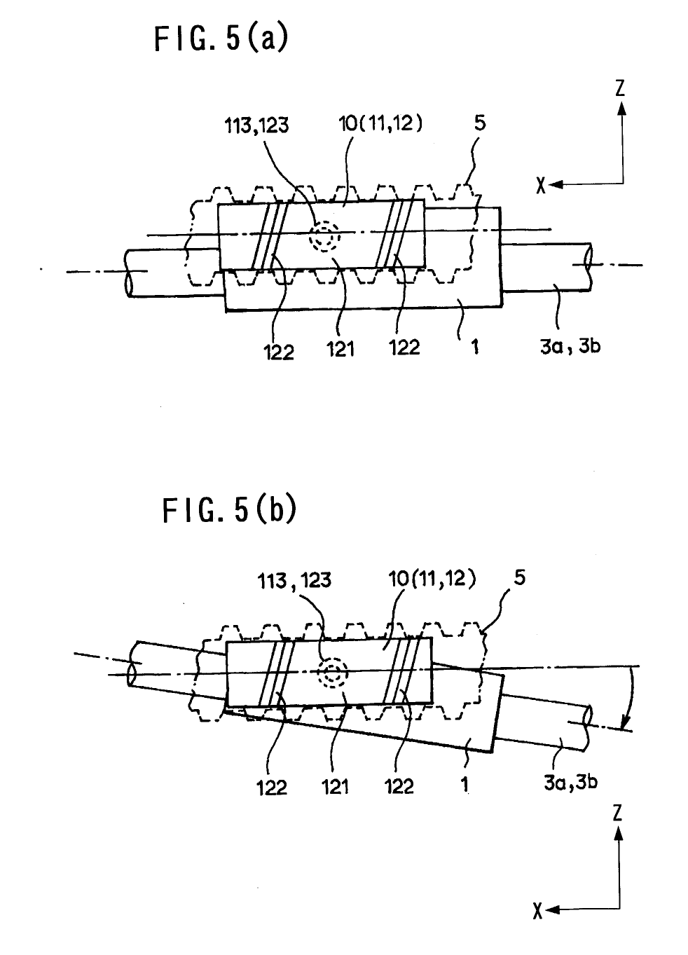

However, when the parallelism between the lead screw 5 and the guide rails is deteriorated in such a manner as described above, in the head driving apparatus of the present embodiment, if a drag generated on a meshing face from an angle difference between the teeth 122 and the screw threads of the lead screw 5 is applied to the toothed member 12, then the toothed member 12 is pivotally moved on the vertical Z-X coordinate plane around the pivot formed from the boss 123 and the bush 113 as exaggeratedly shown in FIG. 5(b) against the frictional force by the tooth spring 14. The pivotal motion of the toothed member 12 is allowed only within a range within which the both of the claw portions 125 can rock in the slits 115, that is, only within a small angular range. Then, if the toothed member 12 is pivotally moved to a position at which the drag is smallest, then the teeth 122 of the toothed member 12 are directed to an angle same as the flank angle of the screw threads of the lead screw 5 and are automatically corrected so that the teeth 122 and the screw threads of the lead screw 5 enter into an appropriate meshing engagement state. Such a correction operation as described above performed by pivotal motion of the toothed member 12 is performed anywhere within a period of time within which the optical pickup unit 1 moves along the guide rails 3a and 3b. Consequently, smooth movement of the optical pickup unit 1 is secured regardless of deterioration of the parallelism between the lead screw 5 and the guide rails 3a and 3b.

Further, the tooth spring 14 brakes the pivotal motion of the toothed member 12 to prevent destabilization of the meshing engagement state between the toothed member 12 and the lead screw 5 caused by excessive pivotal motion of the toothed member 12. Furthermore, since the toothed member 12 and the tooth base 11 are format as the single tooth unit 10, attachment and detachment of the tooth unit 10 to and from the optical pickup unit 1 can be easily performed. It is to be noted that naturally the tooth base 11 may be unitarily formed with the casing la of the optical pickup unit 1.

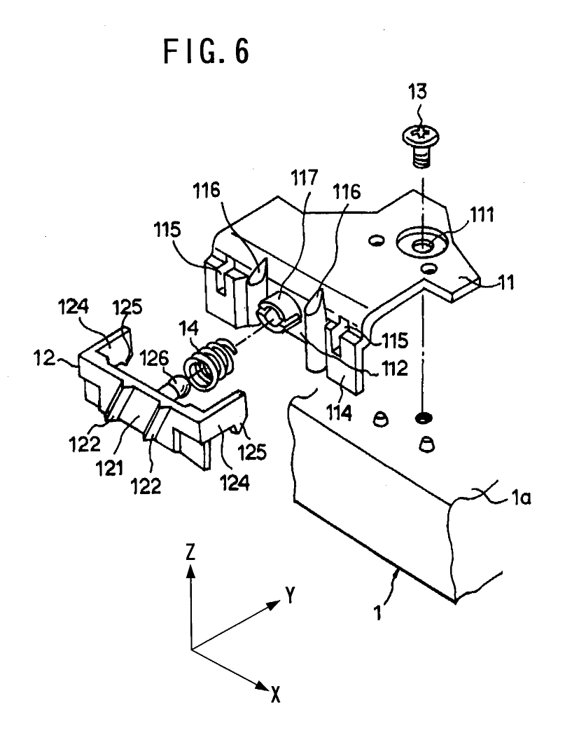

FIG. 6 shows a tooth unit of a modification to the embodiment described above. In the modification shown, the toothed member 12 is formed for pivotal motion not only on the Z-X coordinate plane with respect to the tooth base 11 but also on the X-Y coordinate plane on which the optical pickup unit 1 is moved.

In particular, not such a mere circular boss as described above but a boss 126 having a spherical end is formed in a projecting manner at a central position of the rear face of the front plate portion 121 of the toothed member 12. Further, corresponding to the configuration just described, not such a mere cylindrical bush as described above but a spherical bush 117 having an inside circumferential face formed as a spherical surface is formed in a projecting manner on the tooth base 11. Further, the spherical end of the boss 126 of the toothed member 12 is fitted in the spherical bush 117 of the tooth base 11 to form a spherical bearing structure. It is to be noted that the spherical bush 117 has some room wherein the spherical end of the boss 126 can be moved in an axial direction. Further, similarly as in the embodiment described above, the both side claw portions 125 of the toothed member 12 are inserted in the both side slits 115 of the tooth base 11 such that a space is formed between the claw portions 125 and the slits 115.

According to the modification, similarly as in the embodiment described above, the toothed member 12 can pivotally move in a small angle on the Z-X coordinate plane perpendicular with respect to the tooth base 11 by the spherical bearing structure formed from the boss 126 and the spherical surface bush 117. Consequently, smooth movement of the optical pickup unit 1 is achieved regardless of deterioration of the parallelism between the guide rails 3a and 3b and the lead screw 5 in the Z-axis direction.

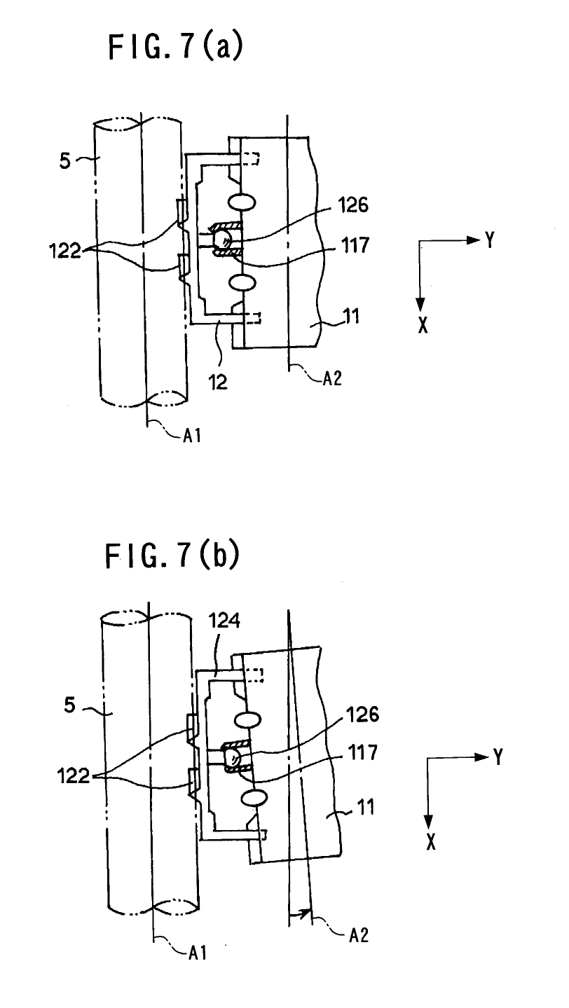

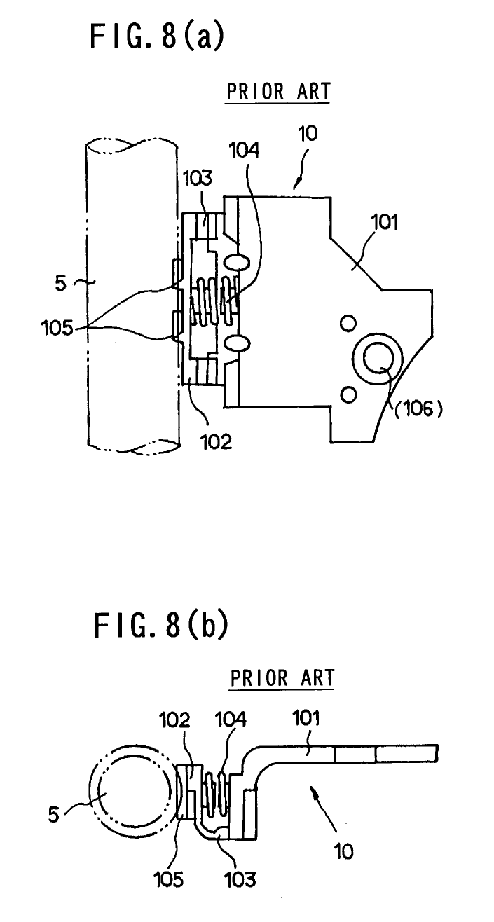

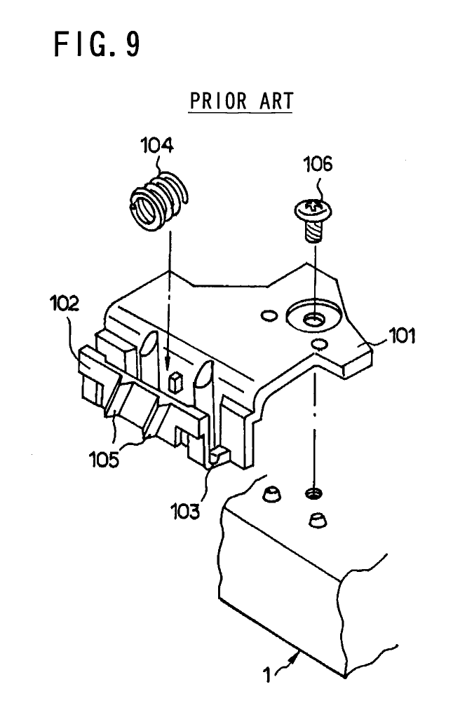

Further, since the spherical bearing structure is formed from the boss 126 and the spherical bush 117, the toothed member 12 can pivotally move also on the X-Y coordinate plane as seen in FIG. 7(a) and 7(b). The pivotal motion of the toothed member 12 is allowed only within a range within which the both side claw portions 125 can be rocked in the both side slits 115 in a widthwise direction thereof. Accordingly, where an axial line of the main guide rail 3a is inclined in the Y-axis direction on the X-Y coordinate plane with respect to an axial line A1 of the lead screw 5 to deteriorate the parallelism, the toothed member 12 is pivotally moved on the X-Y coordinate plane with respect to the tooth base 11 as shown in FIG. 7(b) by a drag which is generated between the teeth 122 of the toothed member 12 and the screw threads of the lead screw 5 when the optical pickup unit 1 moves along the guide rails 3a and 3b. Consequently, since the teeth 122 can be usually directed to the direction along the axial direction of the lead screw 5, smooth movement of the optical pickup unit 1 can be achieved also in this case.

It is to be noted that the present invention is not limited to an optical head driving apparatus for an optical disk apparatus, but can be applied also to a recording disk apparatus which includes a function for adjusting the skew of guide rails in order to adjust the angle of a pickup head with respect to a recording disk. Also, for example, in a magneto-optical disk apparatus, since a function for adjusting the angle of a magneto-optical head with respect to a magneto-optical disk is demanded, the present invention can be applied also to the magneto-optical head driving apparatus.

While a preferred embodiment of the present invention has been described using specific terms, such description is for illustrative purposes only, and it is to be understood that changes and variations may be made without departing from the spirit or scope of the following claims.

What is claimed is:

1. A head driving apparatus for a disk apparatus, comprising:
a pickup head movable in an X-axis direction on a plane of X-Y coordinates along a guide rail for performing recording or reproduction of information onto or from a recording disk;
a lead screw rotationally driven to move said pickup head in the X-axis direction; and
a toothed member held in meshing engagement with said lead screw for moving said pickup head in the X-axis direction upon rotation of said lead screw;
said toothed member being supported for pivotal motion on said pickup head within a range of a small angle on a plane of Z-X coordinates perpendicular to the X-Y coordinate plane on which said pickup head is moved.

2. A head driving apparatus as claimed in claim 1, wherein said toothed member is supported for pivotal motion on said pickup head within a range of a small angle also in the X-Y coordinate plane on which said pickup head is moved.

3. A head driving apparatus as claimed in claim 1, wherein said toothed member is disposed for pivotal motion with respect to said pickup head by means of a pivot extending in a Y-axis direction.

4. A head driving apparatus as claimed in claim 3, further comprising a tooth base provided on said pickup head, and wherein said toothed member is supported for pivotal motion on said tooth base by said pivot extending in the Y-axis direction.

5. A head driving apparatus as claimed in claim 4, further comprising a tooth spring interposed between said toothed member and said tooth base for resiliently pressing said toothed member to said lead screw and braking the pivotal motion of said toothed member.

6. A head driving apparatus as claimed in claim 5, wherein said tooth spring is a coil spring arranged around said pivot.

7. A head driving apparatus as claimed in claim 4, wherein said pivot is formed from a boss provided on a rear face of said toothed member and inserted in a bush provided on a front face of said tooth base.

8. A head driving apparatus as claimed in claim 7, wherein said bush and said boss form a spherical bearing structure.

9. A head driving apparatus as claimed in claim 4, wherein a pair of claw portions are provided on a rear face of said toothed member and inserted in a pair of slits, which are provided on a front face of said tooth base with clearances formed therebetween such that a pivotal motion of said toothed member within a small angle with respect to said tooth base is allowed by the clearances, and removal of said toothed member from said tooth base is prevented by the engagement between said claw portions and said tooth base.

10. A head driving apparatus as claimed in claim 1, wherein said pickup head is an optical pickup unit.
